(19) United States
(12) Patent Application Publication
(10) Pub. No.: US 2026/0155941 A1
(43) Pub. Date: Jun. 4, 2026

(54) ELECTRONIC DEVICE AND OPERATION METHOD THEREOF

(71) Applicant: Samsung Electronics Co., Ltd., Suwon-si (KR)

(72) Inventor: Junsu CHOI, Suwon-si (KR)

(21) Appl. No.: 19/460,966

(22) Filed: Jan. 27, 2026

Related U.S. Application Data
(63) Continuation of application No. PCT/KR2024/008508, filed on Jun. 20, 2024.

(30) Foreign Application Priority Data
Aug. 25, 2023 (KR) 10-2023-0112190
Sep. 22, 2023 (KR) 10-2023-0127184

(51) Int. Cl. H04L 5/00; H04L 1/00

(52) U.S. Cl. CPC H04L 5/0053; H04L 1/0003

(57) ABSTRACT

An electronic device may include: a wireless communication circuit configured to transmit/receive a wireless signal; at least one processor operatively connected to the wireless communication circuit; a memory in which instructions are stored, wherein at least one processor, individually and/or collectively, is configured to execute the instructions and to cause the electronic device to: map one medium access control (MAC) protocol data unit (MPDU) to each of one or more subcarrier groups; and transmit data to one external electronic device based on the one or more subcarrier groups, wherein each of the one or more subcarrier groups may be a group of subcarriers modulated by the same modulation and coding scheme (MCS).

### CROSS-REFERENCE TO RELATED APPLICATIONS

This application is a continuation of International Application No. PCT/KR2024/008508 designating the United States, filed on Jun. 20, 2024, in the Korean Intellectual Property Receiving Office and claiming priority to Korean Patent Application Nos. 10-2023-0112190, filed on Aug. 25, 2023, and 10-2023-0127184, filed on Sep. 22, 2023, in the Korean Intellectual Property Office, the disclosures of each of which are incorporated by reference herein in their entireties.

### BACKGROUND

### Field

The disclosure relates to an electronic device and an operating method thereof.

### Description of Related Art

With the advent of electronic devices such as a smartphone, a tablet PC, or a laptop, the demand for high-speed wireless connectivity has exploded. These trends and the growing demand for high-speed wireless connectivity have firmly established the IEEE 802.11 wireless communication standard as a representative and universal high-speed wireless communication standard in the information technology (IT) industry. Early wireless local area network (LAN) technologies developed around 1997 could support transmission speeds of up to 1 to 2 megabits per second (Mbps). Since then, based on the demand for faster wireless connectivity, wireless LAN technologies have steadily developed, including new wireless LAN technologies that improve transmission speeds, such as IEEE 802.11n, 802.11ac, or 802.11ax. The current latest standard, IEEE 802.11 ax, has a maximum transmission speed of several gigabits per second (Gbps).

Today, wireless LANs provide high-speed wireless connections to users in various public places such as offices, airports, stadiums, or stations, in addition to private places such as homes. Accordingly, wireless LAN has greatly influenced people's lifestyles or culture and has become a lifestyle in modern life.

### SUMMARY

An electronic device according to an example embodiment may include: a wireless communication circuit configured to transmit and receive a wireless signal; at least one processor, comprising processing circuitry, operatively connected to the wireless communication circuit; memory storing instructions, wherein at least one processor, individually and/or collectively, may be configured to execute the instructions and to cause the electronic device to: map one medium access control (MAC) protocol data unit (MPDU) to each of one or more subcarrier groups; and transmit data to one external electronic device based on the one or more subcarrier groups, wherein each of the one or more subcarrier groups may be a group of subcarriers modulated with the same modulation and coding scheme (MCS).

A method of operating an electronic device according to an example embodiment may include: mapping one medium access control (MAC) protocol data unit (MPDU) to each of one or more subcarrier groups; and transmitting data to one external electronic device based on the one or more subcarrier groups, wherein each of the one or more subcarrier groups may be a group of subcarriers modulated with the same MCS.

An electronic device according to an example embodiment may include: a wireless communication circuit configured to transmit and receive a wireless signal; at least one processor, comprising processing circuitry, operatively connected to the wireless communication circuit; memory storing instructions, wherein at least one processor, individually and/or collectively, may be configured ot execute the instructions and to cause the electronic device to: allocate at least a portion of a plurality of subcarrier groups to each of a plurality of external electronic devices; map one MPDU to each of the plurality of subcarrier groups; and transmit data to each of the plurality of external electronic devices, wherein each of the plurality of subcarrier groups may be a group of subcarriers modulated with the same MCS.

A method of operating an electronic device according to an example embodiment may include: allocating at least a portion of a plurality of subcarrier groups to each of a plurality of external electronic devices; mapping one MPDU to each of the plurality of subcarrier groups; and transmitting data to each of the plurality of external electronic devices, wherein each of the plurality of subcarrier groups may be a group of subcarriers modulated with the same MCS.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIGS. 1 and 2 are diagrams illustrating a wireless local area network (WLAN) system according to various embodiments.

FIG. 3 is a signal flow diagram illustrating an example link setup operation according to various embodiments.

FIG. 4 is a diagram illustrating an example of a signal field of a physical layer (PHY) header according to various embodiments.

FIG. 5 is a graph illustrating data transmitted through a subcarrier according to various embodiments.

FIGS. 6A, 6B and 6C are diagrams illustrating example rate adaptation according to various embodiments.

FIGS. 7A, 7B, 7C and 7D include diagrams and graphs illustrating example small-scale fading according to various embodiments.

FIG. 8 is a graph illustrating an example method of transmitting data by applying different modulation and coding schemes (MCSs) to each frequency group according to various embodiments.

FIG. 9 is a block diagram illustrating an example configuration of an electronic device, according to various embodiments.

FIGS. 10A, 10B and 10C are diagrams illustrating an example data transmission method according to various embodiments.

FIG. 11 is a diagram illustrating an example signal field of a PHY header of data, according to various embodiments.

FIGS. 12A and 12B are diagrams illustrating an example field embedded with information associated with grouping of subcarriers, according to various embodiments.

FIG. 13 is a flowchart illustrating an example method of operating an electronic device, according to various embodiments.

FIG. 14 is a flowchart illustrating an example method of operating an electronic device, according to various embodiments.

FIG. 15 is a block diagram of an example electronic device in a network environment, according to various embodiments.

### DETAILED DESCRIPTION

Hereinafter, various example embodiments will be described in greater detail with reference to the accompanying drawings. When describing the various embodiments with reference to the accompanying drawings, like reference numerals refer to like elements and a repeated description related thereto will be omitted

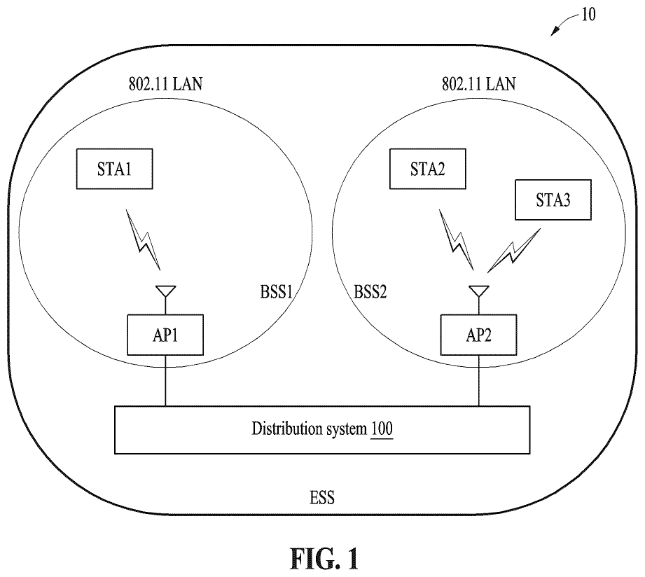

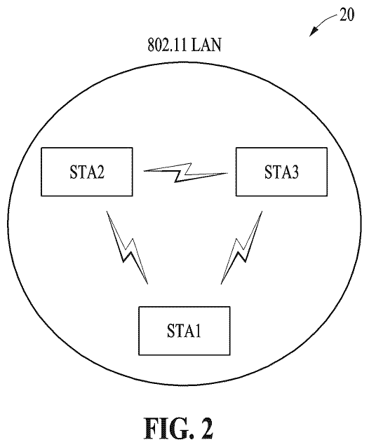

FIGS. 1 and 2 are diagrams illustrating an example wireless local area network (WLAN) system according to various embodiments.

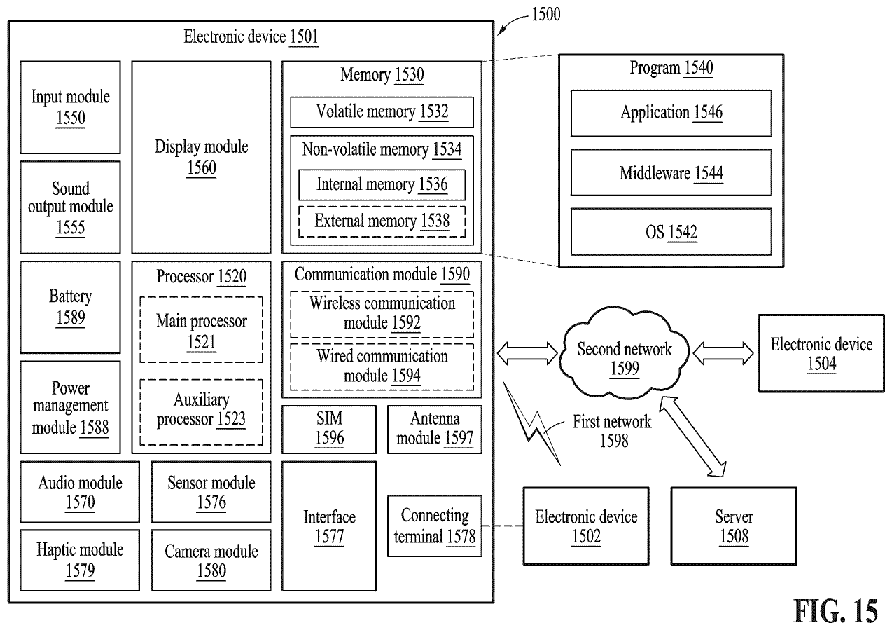

Referring to FIG. 1, according to an embodiment, a WLAN system 10 may refer to an infrastructure mode in which an access point (AP) is present in a structure of a WLAN of the Institute of Electrical and Electronics Engineers (IEEE) 802.11 standard. The WLAN system 10 may include one or more basic service sets (BSSs) (e.g., BSS1 and BSS2). The BSS (e.g., BSS1 or BSS2) may refer to a set of APs (e.g., an electronic device 1502 and an electronic device 1504 of FIG. 15) and stations (STAs) (e.g., an electronic device 1501 of FIG. 15) that may communicate with each other with successful synchronization. The BSS1 may include an AP1 and an STA1, and the BSS2 may include an AP2, an STA2, and an STA3.

According to an embodiment, the WLAN system 10 may include at least one STA (e.g., STA1 to STA3), a plurality of APs (e.g., AP1 and AP2) providing a distribution service, and a distribution system 100 connecting the plurality of APs (e.g., AP1 and AP2). The distribution system 100 may implement an extended service set (ESS), which is a service set extended by connecting a plurality of BSSs (e.g., BSS1 and BSS2). The ESS may refer to one network in which the plurality of APs (e.g., AP1 and AP2) is connected through the distribution system 100. The plurality of APs (e.g., AP1 and AP2) included in one ESS may have the same service set identification (SSID).

According to an embodiment, the STA (e.g., STA1 to STA3) may be an arbitrary functional medium including a medium access control (MAC) and a physical layer interface for a wireless medium that conform to the provisions of the IEEE 802.11 standard. The term “STA” (e.g., STA1 to STA3) may include both an AP-STA and a non-AP STA. The STA (e.g., STA1 to STA3) may also be referred to by various names, such as an electronic device, a mobile terminal, a wireless device, a wireless transmit/receive unit (WTRU), user equipment (UE), a mobile station (MS), a mobile subscriber unit, or simply, a user.

Referring to FIG. 2, according to an embodiment, a WLAN system 20 may refer to an ad-hoc mode in which a network is established and communicated between a plurality of STAs (e.g., STA1 to STA3) without any AP in a structure of a WLAN of the IEEE 802.11 standard, as opposed to the WLAN system 10 of FIG. 1. The WLAN system 20 may include a BSS operating in an ad-hoc mode, for example, an independent basic service set (IBSS).

According to an embodiment, since the IBSS does not include an AP, there may be no centralized management entity that performs a management function at the center. In the IBSS, the STAs may be managed in a distributed manner. In the IBSS, all the STAs may be mobile STAs and may form a self-contained network (or an integrated network) because access to a distribution system is not allowed.

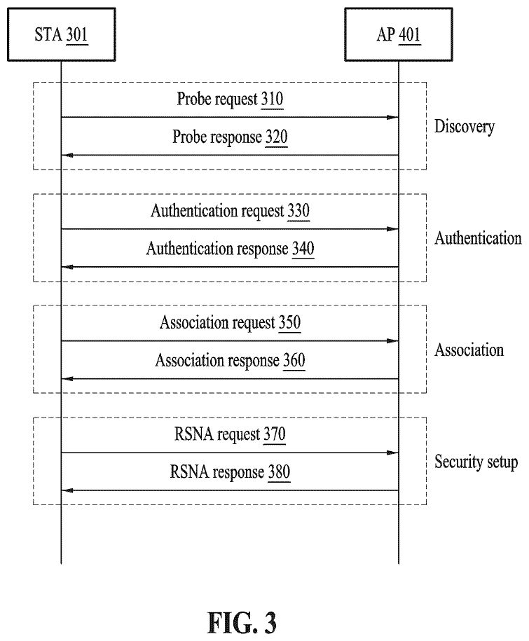

FIG. 3 is a signal flow diagram illustrating an example link setup operation, according to various embodiments.

Referring to FIG. 3, according to an embodiment, the link setup operation may be performed between devices (e.g., an STA 301 and an AP 401) to communicate with each other. For the link setup, operations for network discovery, execution of authentication, establishing association, and setting security may be performed. The link setup operation may be referred to as a session initiation operation or a session setup operation. Furthermore, the operations of discovery, authentication, association, and setting security of the link setup operation may be collectively referred to as an association operation.

According to an embodiment, a network discovery operation may include operations 310 and 320. In operation 310, the STA 301 (e.g., an electronic device 1501 of FIG. 15) may transmit a probe request frame to probe which AP (e.g., an electronic device 1502 or an electronic device 1504 of FIG. 15) exists and may wait for a response to the probe request frame. The STA 301 may find a network to participate in by performing a scanning operation to access the network. The probe request frame may include information of the STA 301 (e.g., a device name and/or address of the STA 301). The scanning operation in operation 310 may refer to an active scanning operation. In operation 320, the AP 401 may transmit a probe response frame to the STA 301 that transmits the probe request frame, in response to the probe request frame. The probe response frame may include information of the AP 401 (e.g., a device name and/or network information of the AP 401). Although FIG. 3 shows that the network discovery operation is performed through active scanning, the disclosure is not necessarily limited thereto. When the STA 301 performs passive scanning, the operation of transmitting the probe request frame may be omitted. The STA 301 that performs passive scanning may receive a beacon frame transmitted by the AP 401 and perform the following subsequent procedures.

According to an embodiment, an authentication operation including operations 330 and 340 may be performed. In operation 330, the STA 301 may transmit an authentication request frame to the AP 401. In operation 340, the AP 401 may determine whether to allow authentication for the STA 301 based on information included in the authentication request frame. The AP 401 may provide the STA 301 with a result of authentication processing through an authentication response frame. The authentication frame used for the authentication request and/or response may correspond to a management frame.

According to an embodiment, the authentication frame may include information on an authentication algorithm number, an authentication transaction sequence number, status code, challenge text, a robust security network (RSN), or a finite cyclic group.

According to an embodiment, an association operation including operations 350 and 360 may be performed. In operation 350, the STA 301 may transmit an association request frame to the AP 401. In operation 360, the AP 401 may transmit an association response frame to the STA 301 in response to the association request frame.

According to an embodiment, the association request frame and/or the association response frame may include information related to various capabilities. For example, the association request frame may include information related to various capabilities, a beacon listening interval, an SSID, supported rates, supported channels, an RSN, a mobility domain, supported operating classes, a traffic indication map (TIM) broadcast request, and/or information related to an interworking service capability. For example, the association response frame may include information related to various capabilities, status code, association ID (AID), supported rates, an enhanced distributed channel access (EDCA) parameter set, a received channel power indicator (RCPI), a received signal-to-noise indicator (RSNI), a mobility domain, a timeout interval (e.g., an association comeback time), an overlapping BSS scan parameter, a TIM broadcast response, and/or information such as a quality of service (QoS) map.

According to an embodiment, a security setup operation including operations 370 and 380 may be performed. The security setup operation may be performed through a robust security network association (RSNA) request/response. For example, the security setup operation may include an operation of performing private key setup by means of a 4-way handshaking through an extensible authentication protocol over local area network (LAN) (EAPOL) frame. The security setup operation may be performed according to a security scheme that is not defined in the IEEE 802.11 standard.

According to an embodiment, a security session may be established between the STA 301 and the AP 401 according to the security setup operation, and the STA 301 and the AP 401 may proceed with secure data communication.

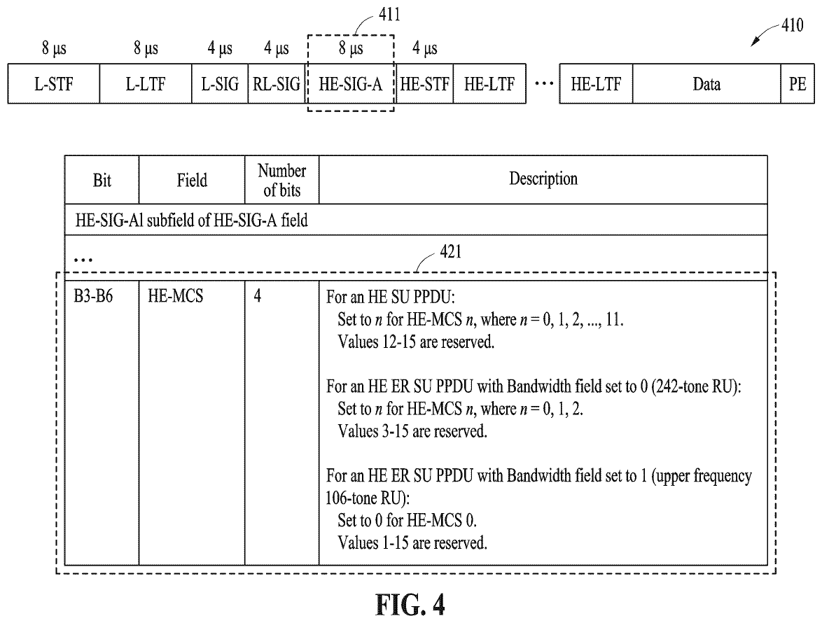

FIG. 4 is a diagram illustrating an example of a signal field of a physical layer (PHY) header according to various embodiments.

Referring to FIG. 4, a signal field 411 of a PHY header 410 may include information about a modulation and coding scheme (MCS). For example, an HE-MCS field 421 of the signal field 411 may include the information about the MCS.

The MCS may include information about how a signal transmitted by a transmitting side is modulated. The transmitting side of the signal may determine the MCS based on a wireless communication environment. In an orthogonal frequency division multiplexing (OFDM) system, the transmitting side may modulate the amplitude and phase of a subcarrier based on the MCS.

The OFDM system may be technology that simultaneously transmits data by allocating the data to different frequency bands. In the OFDM system, the size of the data that may be expressed by one subcarrier may vary depending on the MCS.

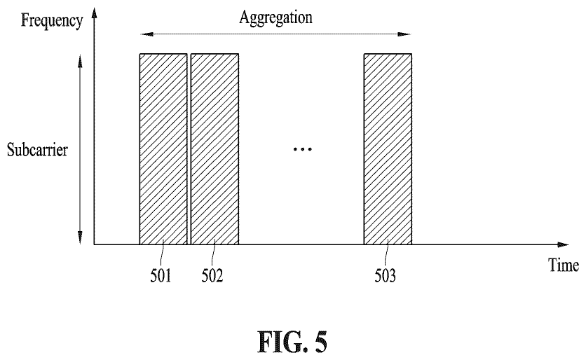

FIG. 5 is a diagram (or graph) illustrating example data transmitted through a subcarrier according to various embodiments.

Referring to FIG. 5, MAC protocol data units (MPDUs) 501, 502, and 503 may be transmitted through the subcarrier.

In the OFDM system, subcarriers in all frequency bands may be used to transmit one MPDU (e.g., 501). The amplitudes and phases of the subcarriers in all frequency bands may be modulated through the same MCS.

The subcarrier may be expressed by Equation 1 below.

$${A}_{k} cos ( 2 π {f}_{k} t + {θ}_{k} ) \qquad [ Equation 1 ]$$

In Equation 1, Aₖ denotes an amplitude of a k-th subcarrier, fₖ denotes a frequency of the k-th subcarrier, and θₖ denotes a phase of the k-th subcarrier. The subcarrier may be distinguished from other subcarriers by frequency. Data may be carried on the subcarrier by modulating the amplitude and phase of the subcarrier.

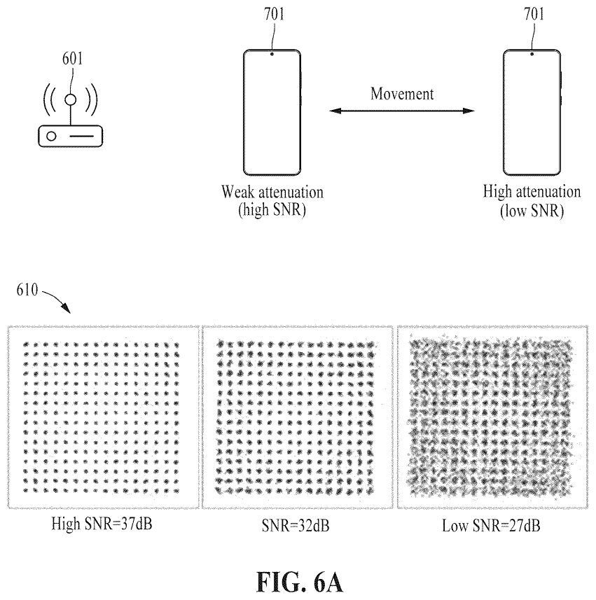

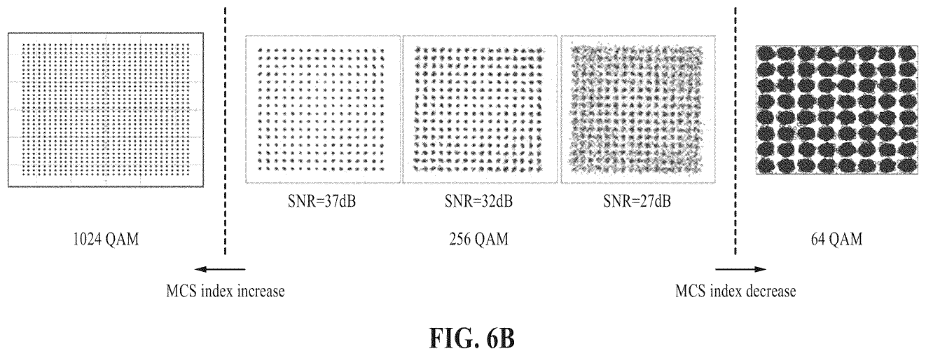

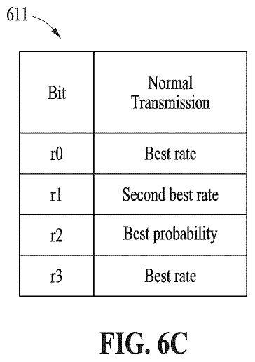

FIGS. 6A, 6B and 6C are diagrams illustrating example rate adaptation according to various embodiments.

Referring to FIG. 6A, as an STA 701 moves, the deviation may occur in a signal between an AP 601 and the STA 701 (e.g., see 610). For example, when the physical distance between the AP 601 and the STA 701 is close, the signal between the AP 601 and the STA 701 may have relatively weak attenuation, and the signal between the AP 601 and the STA 701 may have a high signal-to-noise ratio (SNR). For example, when the physical distance between the AP 601 and the STA 701 increases, the signal between the AP 601 and the STA 701 may have relatively high attenuation, and the signal between the AP 601 and the STA 701 may have a low SNR. The signal with a low SNR may not transmit data completely.

In FIG. 6A, the physical distance between the AP 601 and the STA 701 is used as an example but is not limited thereto, and other wireless communication environments may also cause the deviation in the signal between the AP 601 and the STA 701. Determination of an adaptive MCS in consideration of a wireless communication environment may be required in a wireless communication system. The wireless communication system in consideration of the wireless communication environment may transmit data efficiently while minimizing data loss.

Referring to FIG. 6B, an example of rate adaptation may be identified.

The AP 601 and the STA 701 may adaptively determine an MCS according to the wireless communication environment. For example, when the wireless communication environment is good, the modulation scheme of a subcarrier may be changed (e.g., 256 quadrature amplitude modulation (QAM)->1024 QAM) by increasing an MCS index. The number of bits of data that may be carried on the subcarrier may be increased (e.g., 8 bits->10 bits) by increasing the complexity of the modulation scheme of the subcarrier. For example, when the wireless communication environment is poor, the modulation scheme of the subcarrier may be changed (e.g., 256 QAM->64 QAM) by decreasing the MCS index. By decreasing the complexity of the modulation scheme of the subcarrier, the number of bits of data that may be carried on the subcarrier may be reduced (e.g., 8 bits->6 bits), but data loss may be minimized.

Referring to FIG. 6C, an example of a rate sampling-based rate adaptation algorithm may be identified. The rate sampling-based rate adaptation algorithm may be technology for dynamically adjusting the data transmission rate (e.g., a bitrate) in communication. The rate sampling-based rate adaptation algorithm may be an algorithm that selects an optimal data transmission rate (e.g., a bitrate) according to a changing signal and bandwidth condition in the wireless communication environment.

An electronic device performing the rate sampling-based rate adaptation algorithm may perform sampling transmission and normal transmission. The ratio of the sampling transmission to the normal transmission may be 1:9. The sampling transmission may utilize a random bitrate. The rate sampling-based rate adaptation algorithm may collect sampling transmission results (e.g., success or failure) while changing the bitrate (e.g., utilizing a random bitrate). Through the sampling transmission, the rate sampling-based rate adaptation algorithm may obtain statistics in the changing wireless communication environment.

A table 611 may be an example of a result based on the collected statistics (e.g., sampling transmission results). r0 may be a bitrate used during the initial transmission. The electronic device using the table 611 may use the best bitrate during r0 normal transmission (e.g., initial transmission). r1 may be a bitrate used when transmission fails one time. The electronic device using the table 611 may use the second best bitrate during r1 normal transmission (e.g., second transmission). It should be noted that the table 611 is an example collected by any electronic device that uses the rate sampling-based rate adaptation algorithm. That is, rate adaptation is not limited to the table 611.

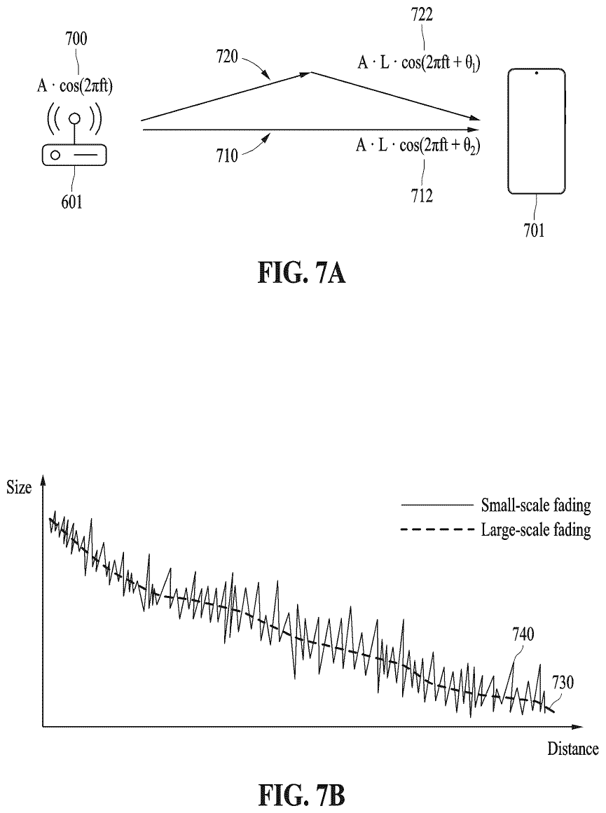

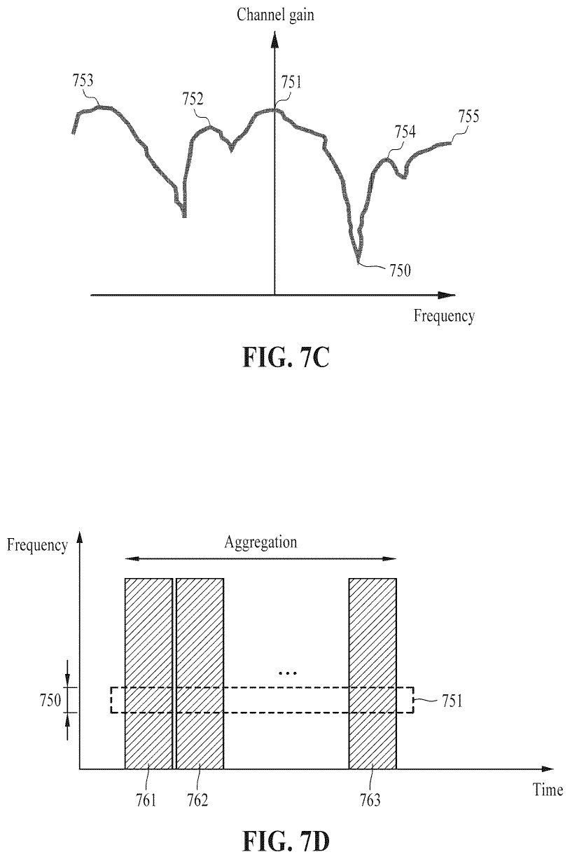

FIGS. 7A, 7B, 7C and 7D are diagrams (including graphs) illustrating example small-scale fading according to various embodiments.

Referring to FIG. 7A, the AP 601 may transmit a signal 700. The signal 700 may propagate through multiple paths 710 and 720. Small-scale fading may occur when the signal 700 propagates through a multi-path.

During the propagation of the signal 700, the signal 700 may be reflected, diffracted, and/or scattered by other objects (e.g., buildings). Signals 712 and 722 may be results of the signal 700 being reflected, diffracted, and/or scattered by other objects (e.g., buildings). The signals 712 and 722 may have different phases (e.g., 01 or 02) by propagating through different paths (e.g., 710 or 720). The signal received by the STA 701 may be a result of overlapping the signals 712 and 722 having different phases. The signal received by the STA 701 may include constructive interference (e.g., the amplitude of the signal increases) based on the phase difference between the signals 712 and 722. The signal received by the STA 701 may include destructive interference (e.g., the amplitude of the signal decreases) based on the phase difference between the signals 712 and 722.

Referring to FIG. 7B, large-scale fading 730 and small-scale fading 740 may be identified. The large-scale fading 730 may be a phenomenon in which the amplitude of a received signal decreases relatively uniformly based on the distance (e.g., a physical distance) between the AP 601 and the STA 701. The small-scale fading 740 may be a phenomenon in which the fluctuation in the amplitude of a received signal exists based on the multi-path (e.g., various propagation paths of a signal).

Referring to FIG. 7C, a result of observing a small-scale fading phenomenon in the frequency band may be identified. That is, the channel gain may vary depending on frequencies (e.g., 750, 751, 752, 753, 754 and 755) of subcarriers. Each of the subcarriers may have a different frequency and phase, and the results of small-scale fading occurring in each of the subcarriers may also vary. For example, a subcarrier having a frequency 750 may have a minimum channel gain, and data transmitted through the subcarrier of the frequency 750 may not be completely transmitted to a receiving side.

Referring to FIG. 7D, a data area 751 transmitted through the subcarrier of the frequency 750 may not be completely transmitted to an external electronic device. The data area 751 that is not transmitted completely may span the entire MPDUs 761, 762, and 763. In this case, the entire data (e.g., an aggregated MPDU (A-MPDU) in which the MPDUs 761, 762, and 763 are aggregated) may not be completely transmitted.

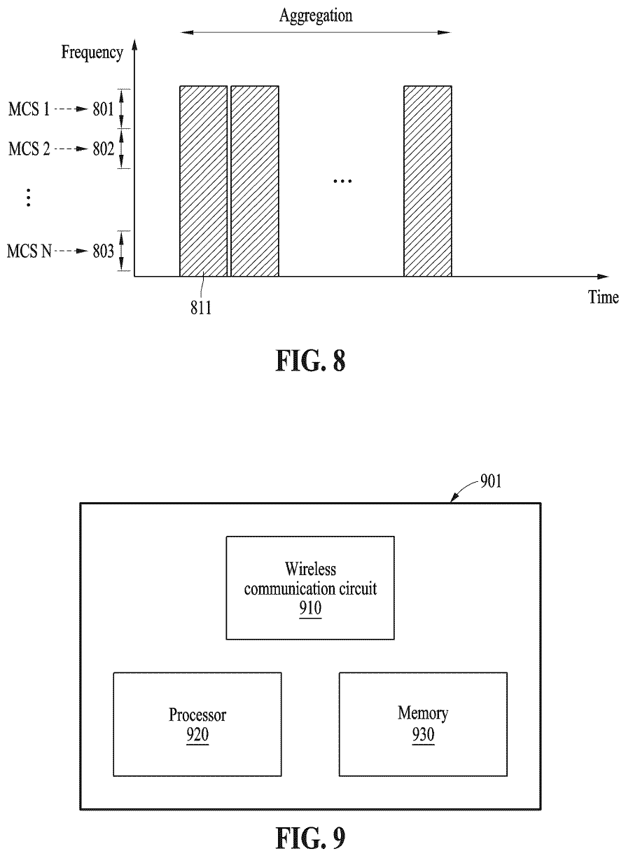

FIG. 8 is a diagram (graph) illustrating an example method of transmitting data by applying different MCSs to each frequency group according to various embodiments.

Referring to FIG. 8, an example of a method of applying different MCSs to each subcarrier by considering small-scale fading may be identified. For example, the method may apply a first MCS to a subcarrier (or a subcarrier group) corresponding to a first frequency band 801, apply a second MCS to a subcarrier (or a subcarrier group) corresponding to a second frequency band 802, and apply an N-th MCS to a subcarrier (or a subcarrier group) corresponding to an n-th frequency band 803. However, even when different MCSs are applied to each subcarrier (or subcarrier group), problems may arise when carrying one data frame (e.g., an MPDU) (e.g., 811) on all subcarriers within the bandwidth. The success or failure of data transmission may be identified in units of MPDUs according to the acknowledgment policy. Accordingly, when the transmission of one data frame (e.g., an MPDU) (e.g., 811) fails, it may not be possible to determine which frequency band (or which MCS) has the problem. Accordingly, a rate sampling-based rate adaptation algorithm may not operate normally.

FIG. 9 is a block diagram illustrating an example configuration of an electronic device, according to various embodiments.

According to an embodiment, an electronic device 901 (e.g., the STA 301 of FIG. 3 or the AP 401 of FIG. 4) may adaptively perform modulation on a subcarrier by considering small-scale fading. The electronic device 901 may not carry one data frame (e.g., an MPDU) on all subcarriers within the bandwidth. The electronic device 901 may carry (e.g., map) one data frame (e.g., an MPDU) on a group of subcarriers (e.g., one subcarrier group) modulated with the same MCS.

According to an embodiment, one subcarrier group may be modulated with an MCS that is different from that of other subcarrier groups. Rate adaptation may be performed on one subcarrier group independently of other subcarrier groups.

According to an embodiment, the electronic device 901 may increase the efficiency and reliability of data transmission and reception by performing subcarrier modulation in consideration of small-scale fading.

According to an embodiment, the electronic device 901 may map one data frame (e.g., an MDPU) to one subcarrier group even in an orthogonal frequency division multiple access (OFDMA) system. The electronic device 901 may operate robustly even in the case of performance degradation of the OFDMA system due to a multi-path environment.

Referring to FIG. 9, according to an embodiment, the electronic device 901 may include a wireless communication circuit 910, a processor (e.g., including processing circuitry) 920, and memory 930. The wireless communication circuit 910 may be configured to transmit and receive a wireless signal. The wireless communication circuit 910 may be a wireless fidelity (Wi-Fi) chipset. The processor 920 may be operatively connected to the wireless communication circuit 910. The memory 930 may be electrically connected to the processor 920 and store one or more instructions executable by the processor 920. The electronic device 901 may correspond to an electronic device (e.g., an electronic device 1501 of FIG. 15) to be described with reference to FIG. 15. Therefore, descriptions that overlap with parts that are described with reference to FIG. 15 are omitted. The operations performed by the electronic device 901 may include operations performed by the wireless communication circuit 910 and operations performed by the processor 920 through the wireless communication circuit 910.

According to an embodiment, the memory 930 may include one or more memories. The instructions stored in the memory 930 may be stored in one memory. The instructions stored in the memory 930 may be divided and stored in a plurality of memories. The instructions stored in the memory 930 may be executed by the processor 920 individually or collectively to cause the electronic device 901 to perform the data transmission method according to an embodiment described herein.

According to an embodiment, the processor 920 may be implemented as a system-on-chip (SoC) or circuitry (e.g., processing circuitry) such as an integrated circuit (IC). The processor 920 may include one or more processors. For example, the processor 920 may include a combination of one or more processors, such as a central processing unit (CPU), a graphics processing unit (GPU), a microprocessor unit (MPU), an application processor (AP), and a communication processor (CP). Thus, the processor 920 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the electronic device 901 may generate a data frame (e.g., an A-MPDU) to be transmitted to an external electronic device.

According to an embodiment, the electronic device 901 may receive information associated with grouping of subcarriers from the external electronic device. The information associated with the grouping of the subcarriers may include information about a wireless communication environment. The information associated with the grouping of the subcarriers may include information on whether the grouping of the subcarriers is required. The information associated with the grouping of the subcarriers may include information about the size of a subcarrier group.

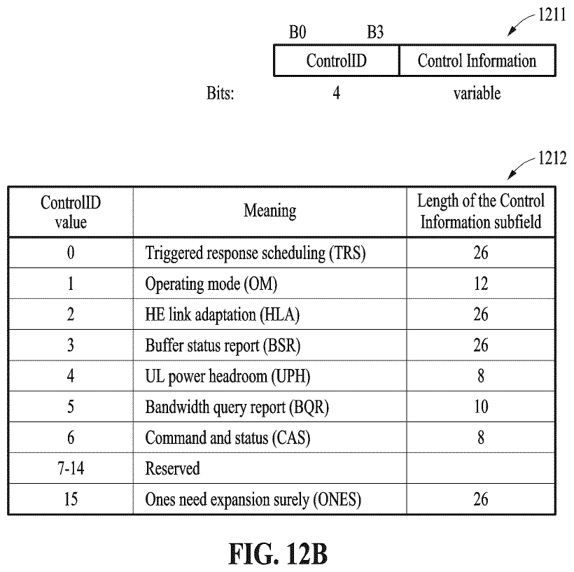

According to an embodiment, the information associated with the grouping of the subcarriers may be included in an operating mode field of an operating mode notification frame transmitted by the external electronic device. The information associated with the grouping of the subcarriers may also be included in an aggregated control (A-control) subfield of a MAC header of a frame transmitted by the external electronic device. This is described in detail with reference to FIGS. 12A and 12B.

According to an embodiment, the electronic device 901 may form one or more subcarrier groups based on the information associated with the grouping of the subcarriers. The electronic device 901 may map one MPDU (e.g., a portion of an A-MPDU) to each of one or more subcarrier groups. That is, the electronic device 901 may modulate the amplitudes and phases of the subcarriers so as to correspond to the mapped MPDU.

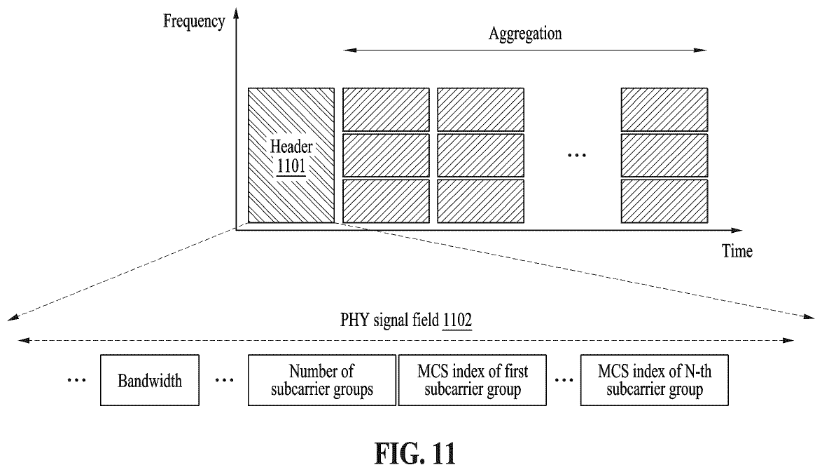

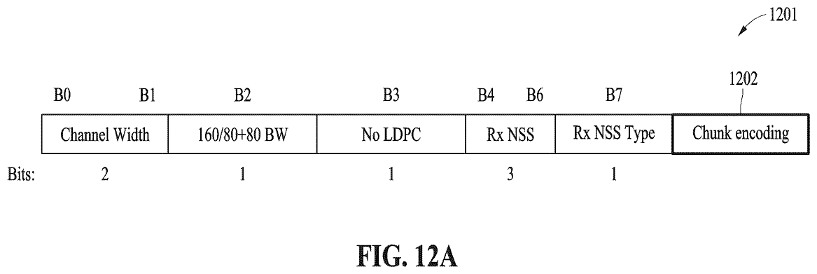

According to an embodiment, the electronic device 901 may transmit data (e.g., an A-MPDU) to one external electronic device based on one or more subcarrier groups. The data (e.g., an A-MPDU) may be a set of different MPDUs modulated by each of one or more subcarrier groups. The different MPDUs may include the same MAC address (e.g., have the same destination), and the data may be transmitted to the one external electronic device. The data may include information about one or more subcarrier groups in a signal field of a PHY header. This is described in greater detail below with reference to FIG. 11.

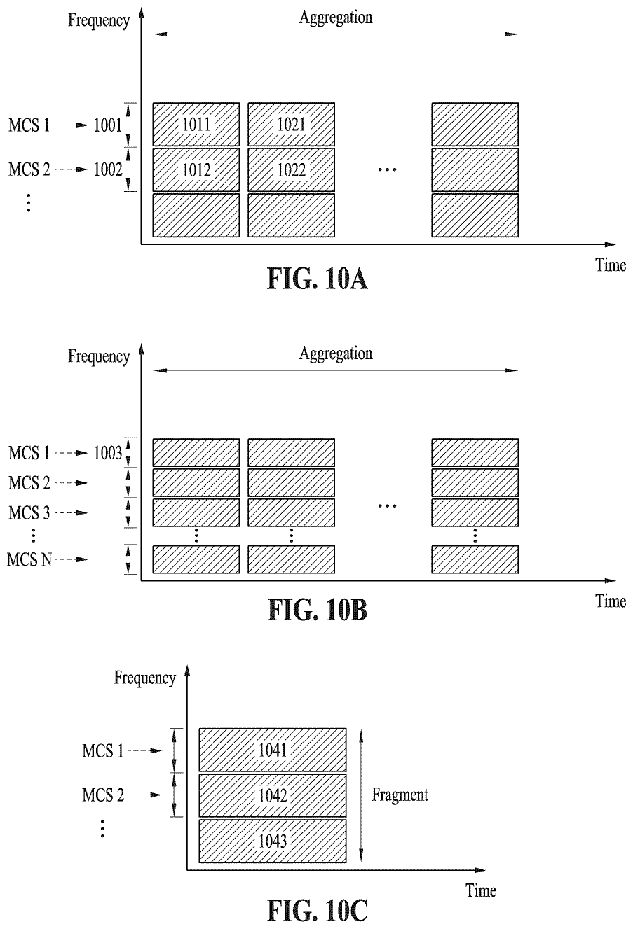

FIGS. 10A, 10B and 10C are diagrams (graphs) illustrating an example data transmission method according to various embodiments.

Referring to FIG. 10A, according to an embodiment, an electronic device (e.g., the STA 301 of FIG. 3, the AP 401 of FIG. 3, or the electronic device 901 of FIG. 9) may form a subcarrier group. For example, the electronic device 901 may form a group of subcarriers (e.g., a first subcarrier group) included in a frequency band 1001. For example, the electronic device 901 may form a group of subcarriers (e.g., a second subcarrier group) included in a frequency band 1002. The first subcarrier group may be a group of subcarriers modulated with a first MCS. The second subcarrier group may be a group of subcarriers modulated with a second MCS. The first MCS and the second MCS may have different indices. It should be noted that each of MCS 1 and MCS 2 shown in FIG. 10A indicates the first MCS or the second MCS and does not refer to an MCS index.

According to an embodiment, the electronic device 901 may map one MPDU to each of one or more subcarrier groups. For example, the electronic device 901 may map an MPDU 1011 to the first subcarrier group (e.g., a group of subcarriers included in the frequency band 1001). For example, the electronic device 901 may map an MPDU 1012 to the second subcarrier group (e.g., a group of subcarriers included in the frequency band 1002). The electronic device 901 may map each of the MPDUs (e.g., 1011 and 1012) sharing the same time resource to a different subcarrier group (e.g., the first subcarrier group or the second subcarrier group). Similarly, the electronic device 901 may map each of MPDUs (e.g., 1021 and 1022) sharing the same time resource to a different subcarrier group.

Referring to FIG. 10B, according to an embodiment, the electronic device 901 may differentiate (e.g., compare FIG. 10A with FIG. 10B) the sizes of subcarrier groups based on information associated with grouping of subcarriers, which is received from an external electronic device. For example, the electronic device 901 may set the size of a subcarrier group to be smaller as there are more multipaths in a wireless communication environment. For example, the frequency band 1001 or 1002 may be smaller than a frequency band 1003. For example, a subcarrier group in the frequency band 1003 may be a result of grouping fewer subcarriers than that of the subcarrier group of the frequency band 1001 or 1002. As described above, the information associated with the grouping of the subcarriers may include information about the wireless communication environment, information about whether the grouping is required, and/or information about the size of the subcarrier group.

Referring to FIG. 10C, according to an embodiment, the electronic device 901 may map one MPDU fragment 1041, 1042, or 1043 to each of one or more subcarrier groups. Acknowledgement of the success or failure of data transmission may be performed in units of MPDU fragments, in addition to MPDUs. The electronic device 901 may apply different MCSs to each MPDU fragment. The electronic device 901 may perform rate adaptation for each MPDU fragment.

FIG. 11 is a diagram (including a graph) illustrating an example signal field of a PHY header of data, according to various embodiments.

Referring to FIG. 11, according to an embodiment, an electronic device (e.g., the STA 301 of FIG. 3, the AP 401 of FIG. 3, or the electronic device 901 of FIG. 9) may include information about a bandwidth and a subcarrier group in a signal field 1102 of a PHY header 1101 of data (e.g., an A-MPDU). The information about the subcarrier group may include grouping information of subcarriers (e.g., the number of subcarrier groups). The information about the subcarrier group may include MCS information for each subcarrier group (e.g., an MCS index of a first subcarrier group to an MCS index of an n-th subcarrier group). The PHY header 1101 may not be transmitted in a frequency division scheme, like data (e.g., an MPDU), but is not limited thereto.

FIGS. 12A and 12B are diagrams illustrating an example field embedded with information associated with grouping of subcarriers, according to various embodiments.

According to an embodiment, an electronic device (e.g., the STA 301 of FIG. 3, the AP 401 of FIG. 3, or the electronic device 901 of FIG. 9) may receive the information associated with the grouping of the subcarriers from an external electronic device. The information associated with the grouping of the subcarriers may include information about a wireless communication environment. The information associated with the grouping of the subcarriers may include information on whether the grouping of the subcarriers is required. The information associated with the grouping of the subcarriers may include information about the size of a subcarrier group.

Referring to FIG. 12A, according to an embodiment, the information associated with the grouping of the subcarriers may be included in an operating mode notification frame transmitted by the external electronic device. The operating mode notification frame may be a frame for notifying other electronic devices about its operating status. The information associated with the grouping of the subcarriers may be included in an operating mode field 1201 of the operating mode notification frame. The information associated with the grouping of the subcarriers may be included in a chunk encoding field 1202. The chunk encoding field 1202 may be a result of extending the operating mode field 1201.

Referring to FIG. 12B, according to an embodiment, an A-control subfield 1211 and a table 1212 indicating information that may be stored in the A-control subfield 1211 may be identified.

According to an embodiment, the information associated with the grouping of the subcarriers may be included in the A-control subfield 1211 of a MAC header of a frame transmitted by the external electronic device.

According to an embodiment, the A-control subfield 1211 may include various pieces of information. The A-control subfield 1211 may include different pieces of information depending on a control identification (ID) value. A control information subfield of the A-control subfield 1211 may have a different number of bits depending on the control ID value. For example, when the control ID value corresponds to 4, the control information subfield may be configured with 8 bits and may include information on uplink power headroom.

According to an embodiment, new control ID may be defined to include the information associated with the grouping of the subcarriers in the MAC header. An optimal field for transmitting the information associated with the grouping of the subcarriers may be defined in a control information subfield corresponding to the new control ID. It may not be necessary to define a new frame when utilizing the A-control subfield 1211. Efficiency may be maximized/improved by utilizing extra resources included in the existing frame without defining the new frame. However, the information associated with the grouping of the subcarriers is not limited to being embedded in the new A-control subfield 1211 and may also be included in a new action frame.

According to an embodiment, the electronic device (e.g., the STA 301 of FIG. 3, the AP 401 of FIG. 3, or the electronic device 901 of FIG. 9) may obtain the information associated with the grouping of the subcarriers not only from information embedded in a frame received from the external electronic device but also from a frame itself received from the external electronic device. For example, by performing channel estimation on the frame received from the external electronic device, the electronic device 901 may identify the degree of small-scale fading (e.g., a range of fluctuations in the strength of a received signal) in the frequency domain. The electronic device 901 may adaptively perform subcarrier grouping depending on the degree of small-scale fading. For example, the electronic device 901 may not perform subcarrier grouping when the degree of small-scale fading is not greater than a preset threshold value. For example, the size of the subcarrier group may be set depending on the size of small-scale fading. The electronic device 901 may perform subcarrier grouping in real time whenever the frame (e.g., any frame) is received from the external electronic device.

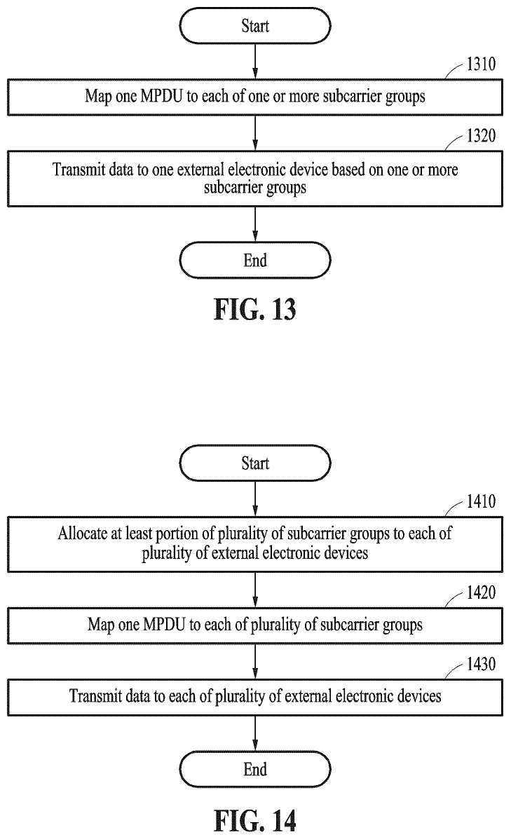

FIG. 13 is a flowchart illustrating an example method of operating an electronic device, according to various embodiments.

Referring to FIG. 13, according to an embodiment, operations 1310 and 1320 may be performed sequentially but not necessarily. For example, the order of operations 1310 and 1320 may be changed, and at least two operations thereof may be performed in parallel.

According to an embodiment, in operation 1310, an electronic device (e.g., the STA 301 of FIG. 3, the AP 401 of FIG. 3, or the electronic device 901 of FIG. 9) may map one MPDU to each of one or more subcarrier groups. The electronic device may modulate the amplitudes and phases of subcarriers so as to correspond to the mapped MPDU. The operations performed by the electronic device may include operations performed by a wireless communication circuit (e.g., the wireless communication circuit 910 of FIG. 9) and operations performed by a processor (e.g., the processor 920 of FIG. 9) through the wireless communication circuit.

According to an embodiment, in operation 1320, the electronic device may transmit data (e.g., an A-MPDU) to one external electronic device based on one or more subcarrier groups. The electronic device may adaptively perform modulation on a subcarrier by considering small-scale fading.

According to an embodiment, the electronic device may increase the efficiency and reliability of data transmission and reception by performing the modulation on the subcarrier in consideration of small-scale fading.

FIG. 14 is a flowchart of illustrating an example method of operating an electronic device, according to various embodiments.

Referring to FIG. 14, according to an embodiment, an electronic device (e.g., the STA 301 of FIG. 3, the AP 401 of FIG. 3, or the electronic device 901 of FIG. 9) may map one data frame (e.g., an MDPU) to one subcarrier group even in an OFDMA system.

According to an embodiment, the OFDMA system may be a system that divides the bandwidth according to the needs of a terminal. The OFDMA system may divide the transmission bandwidth into sets of subcarriers and allocate different sets of subcarriers to different users (e.g., different terminals). Since each of the different terminals occupies a non-overlapping set of subcarriers, the OFDMA system may perform ideal synchronization without interference between multiple users. In the OFDMA system, multiple users may access the same channel simultaneously. The OFDMA system may be a system that divides the entire resource (e.g., time and bandwidth) in the frequency to achieve multi-user access.

According to an embodiment, operations 1410 to 1430 may be performed sequentially but not necessarily. For example, the order of operations 1410 to 1430 may be changed, and at least two operations thereof may be performed in parallel. The operations performed by the electronic device may include operations performed by a wireless communication circuit (e.g., the wireless communication circuit 910 of FIG. 9) and operations performed by a processor (e.g., the processor 920 of FIG. 9) through the wireless communication circuit.

According to an embodiment, in operation 1410, the electronic device may allocate at least a portion of a plurality of subcarrier groups to each of a plurality of external electronic devices.

According to an embodiment, in operation 1420, the electronic device may map one MPDU to each of the plurality of subcarrier groups.

According to an embodiment, in operation 1430, the electronic device may transmit data to each of the plurality of external electronic devices. Different MPDUs modulated by each of the plurality of subcarrier groups may include different MAC addresses. The different MPDUs may be transmitted to different external electronic devices. The electronic device may operate robustly even in the case of performance degradation of the OFDMA system due to a multi-path environment.

FIG. 15 is a block diagram of an example electronic device in a network environment, according to various embodiments.

Referring to FIG. 15, an electronic device 1501 (e.g., the STA 301 of FIG. 3, the AP 401 of FIG. 3, or the electronic device 901 of FIG. 9) in a network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module 1596, and/or an antenna module 1597. In various embodiments, at least one of the components (e.g., the connecting terminal 1578) may be omitted from the electronic device 1501, or one or more other components may be added to the electronic device 1501. In various embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to an embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a CPU or an AP), or an auxiliary processor 1523 (e.g., a GPU, a neural processing unit (NPU), an image signal processor (ISP), a sensor hub processor, or a CP) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521. Thus, the processor 1520 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an ISP or a CP) may be implemented as part of another component (e.g., the camera module 1580 or the communication module 1590) functionally related to the auxiliary processor 1523. According to an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550 or output the sound via the sound output module 1555 or an external electronic device (e.g., the electronic device 1502) (e.g., a speaker or headphone) directly or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly or wirelessly. According to an embodiment, the interface 1577 may include, for example, a high definition multimedia interface (HDMI), a universal serial bus (USB) interface, a secure digital (SD) card interface, or an audio interface.

The connecting terminal 1578 may include a connector via which the electronic device 1501 may be physically connected with the external electronic device (e.g., the electronic device 1502). According to an embodiment, the connecting terminal 1578 may include, for example, an HDMI connector, a USB connector, an SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, ISPs, or flashes.

The power management module 1588 may manage power supplied to the electronic device 1501. According to an embodiment, the power management module 1588 may be implemented as at least part of, for example, a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more CPs that are operable independently from the processor 1520 (e.g., the AP) and support a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device 1504 via the first network 1598 (e.g., a short-range communication network, such as Bluetooth™, Wi-Fi direct, or infrared data association (IrDA)) or the second network 1599 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the mmWave band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element including a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, cloud computing, distributed computing, mobile edge computing (MEC), or client-server computing technology may be used, for example. The electronic device 1501 may provide ultra low-latency services using, e.g., distributed computing or mobile edge computing. In an embodiment, the external electronic device 1504 may include an Internet-of-Things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

An electronic device (e.g., the STA 301 of FIG. 3, the AP 401 of FIG. 3, the electronic device 901 of FIG. 9, or the electronic device 1501 of FIG. 15), according to an example embodiment, may include a wireless communication circuit (e.g., the wireless communication circuit 910 of FIG. 9 or the wireless communication module 1592 of FIG. 15) configured to transmit and receive a wireless signal. The electronic device may include a processor (e.g., the processor 920 of FIG. 9 or the processor 1520 of FIG. 15) operatively connected to the wireless communication circuit. The electronic device may include memory (e.g., the memory 930 of FIG. 9 or the memory 1530 of FIG. 15) storing instructions. The instructions, when executed by the processor individually or collectively, may cause the electronic device to map one MPDU to each of one or more subcarrier groups. The instructions, when executed by the processor individually or collectively, may cause the electronic device to transmit data to one external electronic device (e.g., the electronic device 1504 of FIG. 15) based on the one or more subcarrier groups. Each of the one or more subcarrier groups may be a group of subcarriers modulated with the same MCS.

According to an example embodiment, an MCS applied to each of the one or more subcarrier groups may be different from an MCS applied to other subcarrier groups.

According to an example embodiment, rate adaptation may be performed on each of the one or more subcarrier groups, independently of other subcarrier groups.

According to an example embodiment, the instructions, when executed by the processor individually or collectively, may cause the electronic device to receive information associated with grouping of subcarriers from the one external electronic device. The instructions, when executed by the processor individually or collectively, may cause the electronic device to form the one or more subcarrier groups based on the information associated with the grouping of the subcarriers. The instructions, when executed by the processor individually or collectively, may cause the electronic device to map the one MPDU to each of the one or more subcarrier groups.

According to an example embodiment, the information associated with the grouping of the subcarriers may be included in an operating mode field of an operating mode notification frame transmitted by the one external electronic device.

According to an example embodiment, the information associated with the grouping of the subcarriers may be included in an A-control subfield of a MAC header of a frame transmitted by the one external electronic device.

According to an example embodiment, the data may include information about the one or more subcarrier groups in a signal field of a PHY header.

According to an example embodiment, the information about the one or more subcarrier groups may include grouping information of subcarriers and MCS information for each subcarrier group.

According to an example embodiment, the data may be a set of different MPDUs modulated by each of the one or more subcarrier groups. The different MPDUs may include the same MAC address, and the data may be transmitted to the one external electronic device.

A method of operating an electronic device (e.g., the STA 301 of FIG. 3, the AP 401 of FIG. 3, the electronic device 901 of FIG. 9, or the electronic device 1501 of FIG. 15), according to an example embodiment, may include mapping one MPDU to each of one or more subcarrier groups. The operating method of the electronic device, according to an embodiment, may include transmitting data to one external electronic device (e.g., the electronic device 1504 of FIG. 15) based on the one or more subcarrier groups. Each of the one or more subcarrier groups may be a group of subcarriers modulated with the same MCS.

According to an example embodiment, an MCS applied to each of the one or more subcarrier groups may be different from an MCS applied to other subcarrier groups.

According to an example embodiment, rate adaptation may be performed on each of the one or more subcarrier groups, independently of other subcarrier groups.

According to an example embodiment, the mapping may include receiving information associated with grouping of subcarriers from the one external electronic device. The mapping may include forming the one or more subcarrier groups based on the information associated with the grouping of the subcarriers. The mapping may include mapping the one MPDU to each of the one or more subcarrier groups.

According to an example embodiment, the information associated with the grouping of the subcarriers may be included in an operating mode field of an operating mode notification frame transmitted by the one external electronic device.

According to an example embodiment, the information associated with the grouping of the subcarriers may be included in an A-control subfield of a MAC header of a frame transmitted by the one external electronic device.

A method of operating an electronic device (e.g., the STA 301 of FIG. 3, the AP 401 of FIG. 3, the electronic device 901 of FIG. 9, or the electronic device 1501 of FIG. 15), according to an example embodiment, may include allocating at least a portion of a plurality of subcarrier groups to each of a plurality of external electronic devices (e.g., the electronic device 1504 of FIG. 15). The operating method may include mapping one MPDU to each of the plurality of subcarrier groups. The operating method may include transmitting data to each of the plurality of external electronic devices. Each of the plurality of subcarrier groups may be a group of subcarriers modulated with the same MCS.

According to an example embodiment, different MPDUs modulated by each of the plurality of subcarrier groups may include different MAC addresses. The different MPDUs may be transmitted to different external electronic devices.

According to an example embodiment, the electronic device may be a device configured to support wireless communication based on an OFDMA transmission scheme.

According to an example embodiment, an MCS applied to each of the plurality of subcarrier groups may be different from an MCS applied to other subcarrier groups.

According to an example embodiment, rate adaptation may be performed on each of the plurality of subcarrier groups, independently of other subcarrier groups.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising,
a wireless communication circuit configured to transmit and receive a wireless signal;
at least one processor, comprising processing circuitry, operatively connected to the wireless communication circuit; and
memory storing instructions,
wherein at least one processor, individually and/or collectively, is configured to execute the instructions and to cause the electronic device to:
map one medium access control (MAC) protocol data unit (MPDU) to each of one or more subcarrier groups,
transmit data to one external electronic device based on the one or more subcarrier groups,
wherein each of the one or more subcarrier groups includes a group of subcarriers modulated with the same modulation and coding scheme (MCS).

2. The electronic device of claim 1, wherein an MCS applied to each of the one or more subcarrier groups is different from an MCS applied to other subcarrier groups.

3. The electronic device of claim 1, wherein rate adaptation is performed on each of the one or more subcarrier groups, independently of other subcarrier groups.

4. The electronic device of claim 1, wherein at least one processor, individually and/or collectively, is configured to cause the electronic device to:
receive information associated with grouping of subcarriers from the one external electronic device,
form the one or more subcarrier groups based on the information associated with the grouping of the subcarriers,
map the one MPDU to each of the one or more subcarrier groups.

5. The electronic device of claim 1, wherein the information associated with the grouping of the subcarriers is comprised in an operating mode field of an operating mode notification frame transmitted by the one external electronic device.

6. The electronic device of claim 1, wherein the information associated with the grouping of the subcarriers includes an aggregated control subfield of a MAC header of a frame transmitted by the one external electronic device.

7. The electronic device of claim 1, wherein the data comprises information about the one or more subcarrier groups in a signal field of a physical layer (PHY) header.

8. The electronic device of claim 1, wherein the information about the one or more subcarrier groups comprises,
grouping information of subcarriers; and
MCS information for each subcarrier group.

9. The electronic device of claim, wherein the data is a set of different MPDUs modulated by each of the one or more subcarrier groups,
wherein the different MPDUs comprise the same MAC address, and the data is transmitted to the one external electronic device.

10. A method of operating an electronic device comprising,
mapping one medium access control (MAC) protocol data unit (MPDU) to each of one or more subcarrier groups; and
transmitting data to one external electronic device based on the one or more subcarrier groups,
wherein each of the one or more subcarrier groups is a group of subcarriers modulated with the same modulation and coding scheme (MCS).

11. The method of operating the electronic of claim 10, wherein an MCS applied to each of the one or more subcarrier groups is different from an MCS applied to other subcarrier groups.

12. The method of operating the electronic of claim 10, wherein rate adaptation is performed on each of the one or more subcarrier groups, independently of other subcarrier groups.

13. The method of operating the electronic of claim 10, wherein the mapping comprises,
receiving information associated with grouping of subcarriers from the one external electronic device;
forming the one or more subcarrier groups based on the information associated with the grouping of the subcarriers; and
mapping the one MPDU to each of the one or more subcarrier groups.

14. The method of operating the electronic device of claim 10, wherein the information associated with the grouping of the subcarriers includes an operating mode field of an operating mode notification frame transmitted by the one external electronic device.

15. The method of operating the electronic device of claim 10, wherein the information associated with the grouping of the subcarriers includes an aggregated control subfield of a MAC header of a frame transmitted by the one external electronic device.

16. A method of operating an electronic device comprising,
allocating at least a portion of a plurality of subcarrier groups to each of a plurality of external electronic devices;
mapping one MPDU to each of the plurality of subcarrier groups; and
transmitting data to each of the plurality of external electronic devices, and wherein each of the plurality of subcarrier groups is a group of subcarriers modulated with the same MCS.

17. The method of operating the electronic device of claim 16, wherein different MPDUs modulated by each of the plurality of subcarrier groups includes different MAC addresses,
wherein the different MPDUs is transmitted to different external electronic devices.

18. The method of operating the electronic device of claim 16, wherein the electronic device is a device configured to support wireless communication based on an OFDMA transmission scheme.

19. The method of operating the electronic device of claim 16, wherein an MCS applied to each of the plurality of subcarrier groups is different from an MCS applied to other subcarrier groups.

20. The method of operating the electronic device of claim 16, wherein rate adaptation is performed on each of the plurality of subcarrier groups, independently of other subcarrier groups.
